(19) United States
(12) Patent Application Publication
(10) Pub. No.: US 2010/0034450 A1
(43) Pub. Date: Feb. 11, 2010

(54) METHOD AND DEVICE FOR PRODUCING A TOMOSYNTHETIC 3D X-RAY IMAGE

(76) Inventor: Thomas Mertelmeier, Erlangen (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/531,729

(22) PCT Filed: Nov. 17, 2008
(86) PCT No.: PCT/EP08/65663

§ 371 Date: Sep. 17, 2009

(30) Foreign Application Priority Data
Jan. 15, 2008 (DE) 10 2008 004 473.3

(51) Int. Cl. G06K 9/00; H05G 1/60

(52) U.S. Cl. 382/131; 378/21

(57) ABSTRACT

In a method and device for producing a tomosynthetic 3D x-ray image, a number of 2D projection images of an examination subject are acquired using a fixed x-ray source. The x-ray source has multiple, individually controllable emitters that respectively emit a single x-ray dose from various different directions. The tomosynthetic 3D image is reconstructed from the individual 2D projection images, and at least one 2D projection image is composed of multiple individual images.

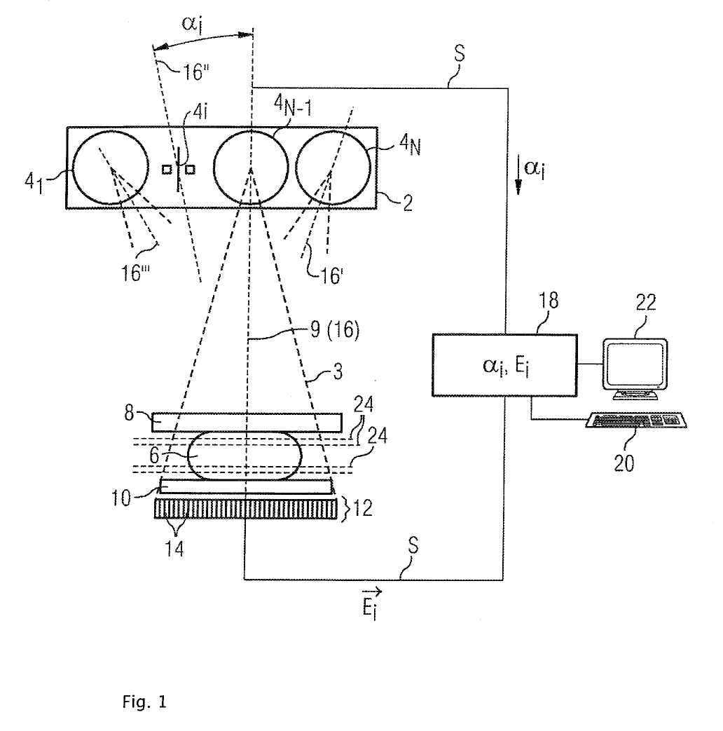

### BACKGROUND OF THE INVENTION

1. Field of the Invention

The invention concerns a method that is in particular suitable for mammography, as well as a device to generate a tomosynthetic 3D x-ray image. In such a tomosynthetic method, a number of x-ray images of an examination subject are acquired from different directions. The tomosynthetic 3D x-ray image is subsequently calculated from the 2D projection images obtained in this way.

2. Description of the Prior Art

A tomosynthetic 3D x-ray image is an image data set that is composed of slice images. Such an image data set acquired via reconstruction of 2D projection images is designated in the following as a tomosynthetic 3D x-ray image or 3D tomosynthesis image.

Mammography concerns an x-ray examination of the breast with the goal of detecting malignant tumors at an optimally early stage. Through continuous improvement of imaging methods it is sought to generate x-ray images with greater significance in order to differentiate malignant variations and thus to reduce the number of incorrect findings. The number of suspicious findings that are not caused by malignant variations and the number of undetected malignant tumors are thus considered incorrect findings. In conventional mammography methods, the examination subject (normally a female breast) is radioscoped in a single projection direction, and a two-dimensional projection image of the compressed breast is generated. In such a projection image tissue layers situated one after another are shown superimposed in the direction of the x-ray beam, such that strongly absorbent benign structures possibly occlude a malignant tumor and thus hinder its ability to be detected.

In order to counter such disadvantages, a mammography method known from Tao Wu et al. “Tomographic mammography using a limited number of low-dose cone-beam projection images”, Med. Phys. 30, 365 (2003) and designated as tomosynthesis is proposed, for example. In such a method, a single digital image of the projection of the female breast is respectively acquired from a plurality of different directions. As already mentioned, these 2D projection images acquired from different directions are processed into a tomosynthetic 3D x-ray image. In such a 3D x-ray image it is possible to map tissue structures that are viewed as being situated deeper in the propagation direction of the x-ray beam.

In conventional tomosynthesis methods, the x-ray source (possibly also the detector) is pivoted opposite the examination subject (for example on an orbit). Novel x-ray sources have multiple emitters that are arranged in parallel and make a pivot motion of the x-ray source superfluous. As an alternative to the pivot movement of the x-ray source, the individual emitters are excited to emission in series so that the examination subject is exposed from different directions.

X-ray sources whose individual emitters operate with field emission cathodes are of particular interest. Such an x-ray source as well as its possible use are proposed by J. Zhang et al. in “A multi-beam x-ray imaging system based on carbon nanotube field emitters”, Medical Imaging, Vol. 6142, 614204 (2006), for example.

An x-ray source composed of multiple emitters allows a high scan speed since this is not limited by a mechanical movement of the x-ray tube. However, the radiation power of the individual emitters is relatively low in comparison to conventional x-ray tubes. This leads to a low signal-to-noise of the acquired 2D projection images and of the computed 3D x-ray image.

### SUMMARY OF THE INVENTION

An object of the present invention to provide a method and a device to generate a tomosynthetic 3D x-ray image which allow an exposure of an examination subject with a higher dose.

In the method for generation of a tomosynthetic 3D x-ray image according to the invention, a number of 2D projection images are acquired with a stationary x-ray source that comprises a plurality of emitters that are arranged in parallel and can be activated individually. The examination subject is exposed from different directions associated with the individual emitters; the respective 2D projection image that is created is acquired with a digital x-ray detector. The tomosynthetic 3D x-ray image is subsequently reconstructed from the 2D projection images. At least one 2D projection image consists of a plurality of individual images. These are created via exposure of the examination subject with a single dose emitted by an emitter. A number of single images are generated by multiple individual doses being emitted by one and the same emitter.

The method according to the invention has the following advantages. Since the maximum individual dose that can be generated by a single emitter of the x-ray source is limited, a plurality of single images can be generated via repeated activation of the same emitter, and thus the dose provided for the exposure of a 2D projection image can be increased. Moreover, by repeated activation of individual emitters the possibility arises to adjust a distribution of the total dose emitted by the x-ray source. For example, a few projections of the examination subject can thus be acquired with a higher dose, which leads to the situation that the quality of the subsequently computed tomosynthetic 3D x-ray image can be improved. By the individual activation of the emitters it is moreover possible to compensate for a non-uniform dose distribution in the 3D tomosynthesis image that is due to the exposure geometry. This is explained using the following example. An examination subject is often a female breast fixed between two compression plates. Those x-rays which emanate from the emitters that enclose a small angle with a surface normal of the aforementioned compression plates travel a comparably short path through the examination subject. In contrast to this, those x-rays which emanate from emitters that enclose a large angle with the surface normals travel a comparably longer path through the examination subject. The individual dose emitted by such emitters is therefore severely attenuated. The consequence is a non-uniform dose distribution that can be compensated in that those emitters that enclose a large angle with the surface normal emit multiple individual doses to generate a 2D projection image.

The method according to the invention can accordingly also have the following additional features.

In an x-ray source having multiple emitters that can be activated individually, the x-ray dose that can be released by a single emitter is limited, since the danger exists that the (comparably small) x-ray emitter thermally may overheat. To solve this problem, after a first emitter has been activated to emit a first individual dose, an additional emitter different from the first emitter is activated first before this first emitter is activated again to emit an additional individual dose. At least the emission time of the additional emitter is thus provided as a cooldown time. It is possible for a longer cool-down time to occur for the first emitter. For this purpose as many additional emitters as possible can be activated between the individual emission processes of a specific emitter, the individual doses of which additional emitters are likewise used to generate the 3D tomosynthesis image. A maximum cooldown time is thus provided for the first activated emitter without the exposure time for the entire tomosynthetic 3D x-ray image being extended.

In the event that all emitters of the x-ray source must be activated repeatedly to generate a desired total dose (that is determined by a predetermined resolution of the 3D tomosynthesis image, for example), in a simplest case this can ensue so that the emitters are repeatedly activated in series. All emitters of the x-ray source are thus activated in a specific order in a first scan. In the following scans, the emitters are now always reactivated in this specific order. The duration of a complete scan is thus provided as a cooldown time of a single emitter. In such a case, all 2D projection images used for reconstruction of the tomosynthetic 3D x-ray image consist of a plurality of single images. In the simplest case, the emitters are sequentially activated in series from one end to the other end of the x-ray source. For example, if it is an x-ray source with N emitters, these can be activated in order, thus 1, 2, . . . , N; 1, 2, . . . , N.

According to a further embodiment, a predeterminable distribution of the total dose emitted by the x-ray source is achieved in that not all but rather only selected individual emitters are activated more than once. For a simpler activation, the emitters are organized into groups. Those emitters which are activated equally often are assigned to a common group. To simplify the activation process, the emitters are activated in groups. Within a group, the emitters are individually activated sequentially, i.e. in succession. Different groups are always particularly advantageously activated in direct succession. Approximately the sum of the emission times of an additional group are thus always provided to the emitters of each group as a cooldown time.

To improve the diagnosis of pathological tissue, according to a further embodiment an x-ray contrast agent is administered to the patient during or between two successive tomosynthetic x-ray examinations. In such a case, the examination is implemented with different x-ray energies which are selected so that a first x-ray energy is above the absorption edge of the x-ray contrast agent and an additional x-ray energy is below the absorption edge of the x-ray contrast agent. To generate a tomosynthetic 3D x-ray difference image, the emitters of the x-ray source are activated such that their emitted individual doses possess different x-ray energies. The individual emitters of the x-ray source are initially operated with a first energy to generate a first set of 2D projection images; the emitters are operated with a second x-ray energy to generate an additional set of 2D projection images. The two acquired sets of 2D projection images are computed into two different 3D x-ray images or into one 3D x-ray difference image. That tissue in which the x-ray contrast agent has accumulated is particularly well visible in such a 3D x-ray difference image. For generation of 2D projection images of different x-ray energy it can also be desirable to acquire these with increased intensity. For this purpose the emitters of the x-ray source can be repeatedly activated individually or in groups as already explained above.

For further simplification of the activation, according to a further embodiment a constant product of current and emission time is provided for all emitters of the x-ray source. It is thus advantageously possible to control the exposure of a 2D projection image merely via the number of required individual doses.

The object is moreover achieved with a device according to the invention wherein the x-ray source of the device has at least one emitter that has a field emission cathode which is formed of carbon nanotubes. Moreover, the device has an x-ray detector with low inherent noise. With a field emission cathode whose field emitter consists of carbon nanotubes, it is possible to generate individual x-ray doses with nearly arbitrary temporal shape. Moreover, such cathodes can easily be miniaturized. An x-ray detector with low inherent noise is particularly advantageous since multiple individual images are added to calculate a 2D projection image. A low inherent noise of the x-ray detector prevents that a 2D projection image with a poor signal-to-noise ratio is obtained as a result of the addition of the individual images.

Additional significant advantages of the device have already been cited in connection with the method according to the invention.

The device is preferably a mammography device.

### BRIEF DESCRIPTION OF THE DRAWINGS

The single FIGURE is a schematic representation of a mammography device for generation of a tomosynthetic 3D x-ray image, in accordance with the invention.

### DESCRIPTION OF THE PREFERRED EMBODIMENTS

The FIGURE shows a mammography device with an x-ray source 2 that has a plurality of emitters 4. Shown is an x-ray source 2 with N emitters 4₁ through 4_{N}. The individual emitters 4 are arranged in parallel in the manner of an array and generate x-rays 3 that expose an examination subject 6 (a female breast in the present case). The individual emitters 4 are arranged so that they expose the examination subject 6 from different angles α. The exposure direction 16″ of the i-th emitter 4ᵢ thereby encloses the angle αᵢ with a surface normal 9. To adjust the exposure directions 16, 16′, 16″, 16″′, the emitters 4 can be arranged rotated slightly counter to one another in the x-ray source 2.

The examination subject 6 is fixed between a compression plate 8 and a bearing plate 10. An x-ray detector 12 that is composed of a number of individual detectors 14 in a matrix formation is located on the side of the examination subject 6 facing away from the x-ray source 2. The x-ray detector 12 is aligned essentially parallel to the compression plate and bearing plate 8, 10 so that these components possess the same surface normals 9.

The x-ray source 2 essentially extends perpendicular to the surface normals 9. The individual emitters 4 of the x-ray source 2 can be arranged so that these respectively enclose an angle a with the surface normals 9 so that the examination subject 6 can be exposed from various directions 16, 16′, 16″, 16″′. For reasons of clarity, only three individual emitters 4, 4_{N-i} and 4_{N} are shown. For example, the i-th emitter 4ᵢ (not explicitly shown) should enclose an angle αᵢ with the surface normal 9. The individual emitters 4 of the x-ray source 2 are rotated slightly against one another to adjust the exposure direction 16. If the distance between the detector 12 and the x-ray source 2 is large, the individual emitters 4 can likewise be aligned so that their exposure directions 16 are essentially aligned in parallel.

To generate a tomosynthetic 3D x-ray image, the individual emitters 4 are activated in ascending order. Naturally it is also possible to activate the emitters 4 in an arbitrarily different order. The x-ray detector 12 acquires an associated individual image data set Eᵢ at every exposure direction 16 or at every exposure angle αᵢ. Data that contain information about the exposure angle αᵢ and the associated individual image data sets Eᵢ are sent via a signal line S to a control and processing device 18. The individual image data sets Eᵢ are processed there into a tomosynthetic 3D x-ray image which are analyzed and handled with the aid of various input and display elements which are represented by way of example by a keyboard 20 and a monitor 22. A tomosynthetic 3D x-ray image consists of a plurality of individual slice images which respectively reproduce a slice through the examination subject 6 that is oriented perpendicular to the normal 9. For clarification, a few slice planes 24 through the examination subject 6 are shown.

The emitters 4 of the x-ray source 2 are preferably emitters 4 with a field emission cathode that comprises carbon nanotubes. In order to avoid a thermal overload of the individual emitters 4, these are activated as follows, for example:

According to a first embodiment, the emitters 4 of the x-ray source 2 are activated in series, thus beginning with the first emitter 4₁. If the total dose for the examination subject 6 is not sufficient, the individual emitters 4 are reactivated in the same order, thus beginning again with the emitter 4₁. In order to keep the thermal load of the individual emitter 4 as small as possible, in every case it is prevented that an individual emitter 4 is activated twice in direct succession.

According to a further embodiment, the individual emitters 4 are activated with different frequency. A desired distribution of the total dose emitted by the x-ray source 2 can be set in this way.

For simplification of the activation, the emitters 4 are advantageously divided up into groups. Emitters 4 which respectively radiate a single dose with the same frequency are assigned to the same group. The emitters 4 are activated in groups, wherein within the group the emitters 4 are respectively activated individually in order. In order to achieve a maximum cooldown time for the individual emitters 4, different groups are always activated in different succession.

For explanation it is assumed that the x-ray source 2 shown in FIGURE comprises N=11 emitters 4, for example. A 3D tomosvnthesis image should be acquired in which the central projections are acquired with a higher dose than the edge projections. The emitters 4 with the numbers 1, 2, 3, 9, 10 and 11 are activated once; the emitters 4 with the numbers 4 and 8 are activated twice; and the emitters 4 with the numbers 5, 6 and 7 are activated three times. The emitters 4 with the numbers 1, 2, 3, 9, 10 and 11 are correspondingly associated with a group A; those with the numbers 4 and 8 are associated with a group Band; the emitters 4 with the numbers 5, 6 and 7 are associated with a group C. The groups A through C can now be activated in succession in the following order, for example: C, A, B, C, B, C. The sum of the exposure times of a different group are always provided as a cooldown time for the emitters of every group due to such an order of the activation of the groups.

For simplification of the control of the x-ray source 2, a fixed value for the tube current and the emission time can be established for the individual emitters 4. For example, the current-time product for such a single dose can be 2.5 mAs. The total dose necessary to examine the examination subject 6 is henceforth controlled via the number of the individual doses. If the current-time product of a single dose is 2.5 mAs, this results in a total dose of 62.5 mAs for an x-ray source 2 with N=25 emitters 4. If the imaging of an examination subject 6 requires a total dose of 125 mAs, two scans ensue with 62.5 mAs respectively.

To expand the examination possibilities, an x-ray contrast agent can be administered to the patient between two single tomosynthetic acquisitions or even during the acquisition of a tomosynthesis 3D x-ray image. The x-ray contrast agent typically accumulates in pathological tissue and serves to make this visible. The contrast visible in the image is achieved by acquiring two images with different x-ray energies from the examination subject 6. The x-ray energy of the first image is below an absorption edge of the x-ray contrast agent and that of the second image is above an absorption edge of the x-ray contrast agent. Iodine, which has an absorption edge at 33 keV, is typically used as a contrast agent. Given use of a tungsten anode in the individual emitters 4, the energy of the emitted x-ray radiation is achieved via a displacement of the x-ray braking spectrum.

The displacement of the braking spectrum ensues via a variation of the acceleration voltage. To acquire a 3D x-ray difference image, the 2D projection images necessary for its calculation are acquired with different energies. For example, the emitters 4 of the x-ray source 2 are operated with a first acceleration voltage in a first scan and with a second tube voltage in a second scan. The two sets of 2D projection images that are acquired in this manner are subtracted from one another and processed into a 3D x-ray difference image by means of the control and evaluation unit 18. Depending on the x-ray dose that is necessary for the examination subject 6, multiple single images are acquired in turn to generate the 2D projection images of different x-ray energies and are computed into a 2D projection image.

Although modifications and changes may be suggested by those skilled in the art, it is the intention of the inventor to embody within the patent warranted heron all changes and modifications as reasonably and properly come within the scope of his contribution to the art.

1. Method for generation of a tomosynthetic 3D x-ray image, comprising:
acquiring a plurality of 2D projection images with a stationary x-ray source that has a plurality of emitters that are arranged in parallel and can be activated individually by acquiring said 2D projection images in succession from different directions respectively associated with the individual emitters
generating at least one 2D projection image from a plurality of individual images that are respectively created by exposure of the examination subject with a single dose that is emitted by a single emitter; and
reconstructing a tomosynthetic 3D image form said plurality of 2D projection images.

2. Method according to claim 1 comprising, after a first emitter has been activated to emit a first individual dose, an additional second emitter is activated first before said first emitter is activated again to emit an additional individual dose.

3. Method according to claim 2, in which each of the 2D projection images used for reconstruction of the tomosynthetic 3D x-ray image is composed of a plurality of single images, and comprising after the emitters have respectively emitted a first single dose, to emit an additional individual dose said emitters are activated in series in the same order as this occurred to the emit the first individual dose.

4. Method according to claim 2 comprising dividing those emitters emit a plurality of single doses to generate a 2D projection image into groups using the number of single doses that are emitted by the respective emitter and activating the emitters in succession in said groups.

5. Method according to claim 4, comprising activating groups of emitters that are different from one another in direct succession.

6. Method according to claim 1 comprising predetermining any of the preceding claims, in which the number of single doses to be emitted by a single emitter by a dose distribution provided for the examination subject.

7. Method according to claim 1 comprising generating tomosynthetic 3D x-ray difference image as a 3d x-ray image using the single doses used to generate a 2D projection image exhibit with different x-ray energies.

8. Method according to claim 7, comprising setting the x-ray energy of a first single dose is below an absorption edge of an x-ray contrast agent and setting the x-ray energy of an additional single dose is above an absorption edge of an x-ray contrast agent.

9. Method according to claim 1 comprising predetermining a constant product of current and emission time for all emitters as a parameter for generation of a single dose.

10. (canceled)

11. A device for generation of a tomosynthetic 3D x-ray image, comprising:
a stationary x-ray source comprising a plurality of emitters arranged in parallel that are activated individually to acquire a plurality of 2D projection images in succession from different directions respectively associated with the individual emitters
said x-ray source being operated to generate at least one 2D projection image of a plurality of individual images that are respectively created by exposure of the examination subject with a single dose that is emitted by a single emitter; and
a computer that reconstructs a tomosynthetic 3D image form said plurality of 2D projection images.
